(19) United States
(12) Patent Application Publication
(10) Pub. No.: US 2004/0152494 A1
(43) Pub. Date: Aug. 5, 2004

(54) In-vehicle hands-free cellular phone set

(76) Inventor: Kuo-Chun Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/625,729

(22) Filed: Jul. 24, 2003

(30) Foreign Application Priority Data
Aug. 2, 2002 (CN) 02266005.4

(51) Int. Cl. H04M 1/00

(52) U.S. Cl. 455/569.2; 455/569.1

(57) ABSTRACT

An in-vehicle hands-free cellular phone set is disclosed. It utilizes a pair of radio transmitter/receiver modules workable at similar radio frequency. The two-way communication by call-in and call-out is performed through the two radio transmitter/receiver modules, one built in the cellular phone, and the other set in the sunshade of the vehicle. By means of that, the sunshade can serve as an effective hands-free means for the driver to use the cellular phone conveniently and securely without the need of intricate change-over of wire connection. Other component parts, a loud speaker for call-in voice output and a microphone for call-out voice output, are provided on the same pedestal of the cellular phone set. The power supply for the cellular phone set can be obtained from the vehicle power system or from an exclusive storage battery unit via a power supply switch.

### BACKGROUND OF THE INVENTION

1. Field of the Invention

The present invention relates to an in-vehicle hands-free cellular phone set, and more particularly, to an in-vehicle cellular phone set installed in the sunshade of a vehicle that will enable the driver to use the cellular phone without holding it by hand.

2. Description of the Prior Art

In-vehicle cellular phones have been widely utilized for these several years. It is an astonishing view that the vehicle driver talks over a cellular phone by holding it in one hand and controls the steer wheel by the other while the vehicle is moving. To prevent possible traffic accidents being caused by such an inadvertent behavior, a new traffic regulation has been issued to prohibit using the cellular phone in the vehicle.

In view of this, manufacturers have contrived some in-vehicle hands-free cellular phone sets to meet with the present requirement. The most typical layout is setting the cellular phone together with its speaker on a fixed pedestal or making some improvement over the vehicle acoustic system so as to attain a hands-free purpose. In this manner, an extra space in the vehicle for fixedly installing a cellular phone has to be provided, which is quite inconvenient for the driver to handle.

To avoid the aforementioned shortcomings, the inventor of the present invention has conducted an intensive research based on many years of experience gained through professional engagement in the manufacturing of related products in addition to continuous experiments and improvement. So a new in-vehicle hands-free cellular phone set with improved structure has culminated in realization.

### SUMMARY OF THE INVENTION

Consequently, one of the objects of the present invention is to provide the driver with an in-vehicle hands-free cellular phone set which is installed in the sunshade of the vehicle, so the driver can use it conveniently and securely yet without worrying about degrading the original function of the sunshade.

Another object of the present invention is to provide the driver with an in-vehicle hands-free cellular phone set that enables the driver to make a phone call or to answer a phone call conveniently in the moving vehicle without fearing of any traffic accident due to distraction.

To achieve the aforesaid objects, the hands-free cellular phone set will be installed in the sunshade of a vehicle above the driver's seat. The cellular phone set is composed of a radio transmitter, a receiver module, a speaker, and a microphone. This radio transmitter and the receiver module in vehicle are compatible with the radio transmitter and receiver module built in the cellular phone. Both can transmit and receive the radio communication signals in two directions (outgoing or incoming). A setting switch is provided at the front edge of the sunshade to set the operation mode. After setting the two modules at the same radio frequency, the communication can be performed by switching the connection of the radio transmitter and receiver module in the cellular phone to outgoing or incoming direction so that the cellular phone can transmit the voice signals to the driver outward or receive incoming radio signals into the cellular phone. Thereby, mutual communication can be accomplished through the two transmitter and receiver modules.

### BRIEF DESCRIPTION OF THE DRAWINGS

The above objects and other advantages of the present invention will become more apparent by describing in detail the preferred embodiment of the present invention. Please refer to the attached drawings:

FIG. 1 is a schematic view of the present invention, and

FIG. 2 is a perspective view illustrating the embodiment of the present invention in which the layout of the components is shown.

### DETAILED DESCRIPTION OF THE PREFERRED EMBODIMENT

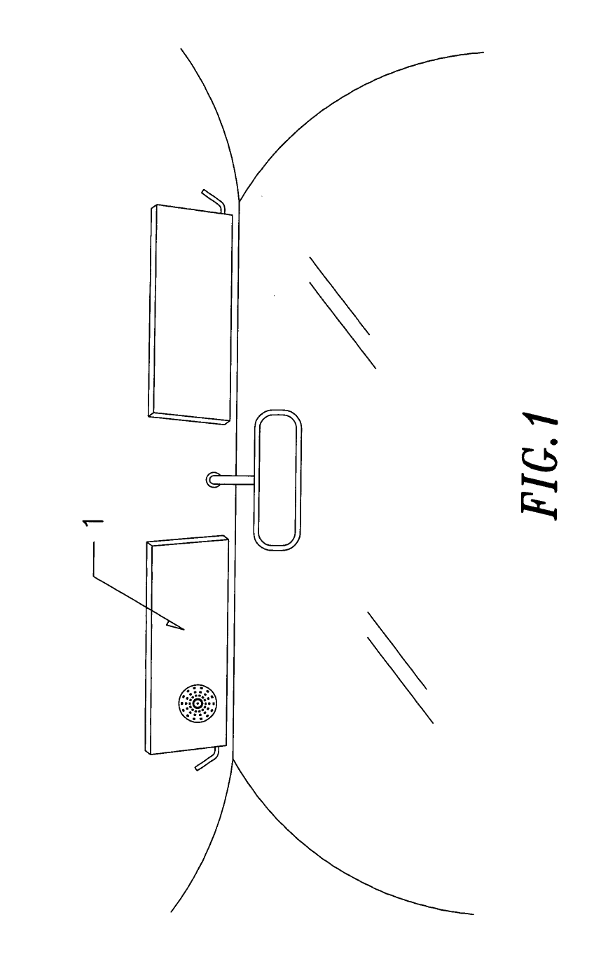

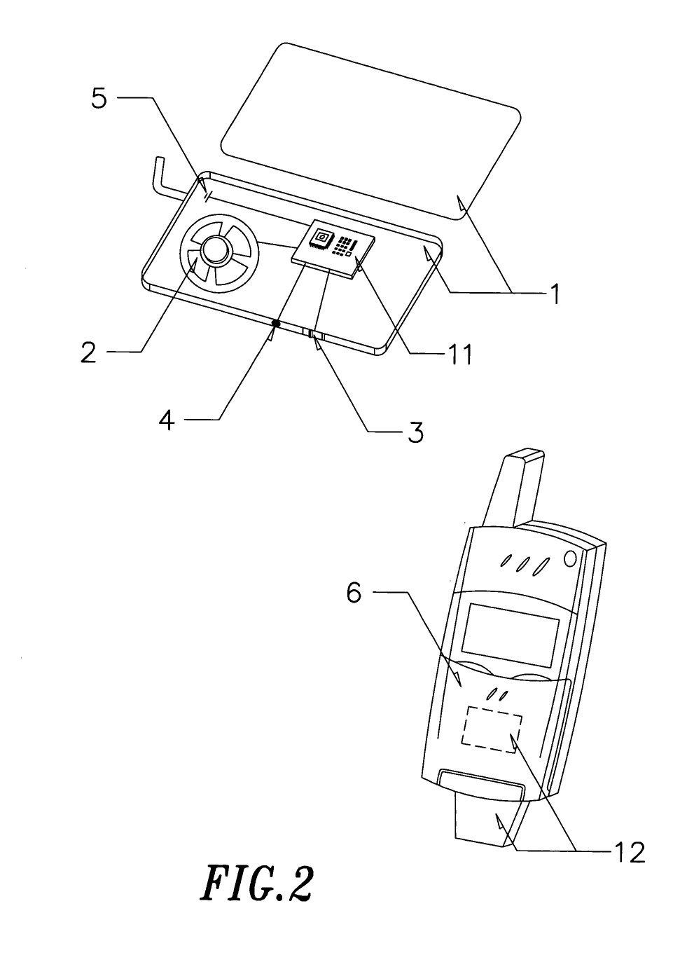

Both FIG. 1 and FIG. 2 show a schematic view and a perspective view of the layout of the components of the present invention. It can be clearly observed that a radio transmitter/receiver module 11 is installed at a proper position of the sunshade 1 of the vehicle. The radio transmitter/receiver module 11 is compatible with the radio transmitter/receiver module 12 built in the cellular phone so that the radio communication signals can be transmitted and received in two directions (outgoing and incoming). A setting switch 3 is provided at the front edge of the sunshade 1 to set the operation mode. After setting the two transmitter/receiver modules 11 and 12 at the same radio frequency, the communication can be performed by changing over the connection of the radio transmitter/receiver module 12 in the cellular phone 6 to outgoing direction or incoming direction to connect with the cellular phone 6. By doing so when there is a call to the cellular phone 6, the call-in signal will be received by the radio transmitter/receiver module 12 and then transferred to the radio transmitter/receiver module 11 set in the sunshade 1, and further transferred to speaker 2 set in the sunshade 1 for outputting an audible voice. On the other hand, the call-out from the driver can be input to a microphone 4 set in the front edge of the sunshade 1. This voice signal will be converted to a radio communication signal by the radio transmitter/receiver module 11 and be emitted from the radio transmitter/receiver module 12 so that the mutual phone communication between the driver in the vehicle and an external telephone can be carried out in the hands-free manner and without the need of intricate change-over of wire connection, which is usually necessary for a conventional hands-free cellular telephone set. Meanwhile, the power supply 5 to the hands-free cellular phone set can be obtained from the vehicle power system or an exclusive storage battery.

In a word, the present invention of in-vehicle hands-free cellular phone set has several noteworthy advantages compared with any conventional product, in particular:

1. The in-vehicle hands-free cellular telephone set installed in the sunshade of the vehicle facilitates the driver to use it conveniently and securely without adversely affecting the function of the sunshade.

2. The driver is able to make a phone call or to answer an incoming phone call conveniently and safely in the advancing vehicle yet without fearing of any traffic accident due to distraction.

Those who are skilled in the art will readily perceive how to modify the invention. Therefore, the appended claims are to be construed as covering all equivalent structures, which comprise the true scope and spirit of the invention.

What is claimed is:

1. In-vehicle hands-free cellular phone sets utilize a pair of radio transmitter/receiver modules workable at similar radio frequency, where the two-way communication of call-in and call-out is performed by the said two radio transmitter/receiver modules, one built in the said cellular phone, and the other set in the said sunshade of the vehicle; hence, the said sunshade serves as an effective hands-free means for the driver to use the cellular phone conveniently and securely without the need of intricate change-over of wire connection.
